(19) United States
(12) Patent Application Publication
(10) Pub. No.: US 2016/0041001 A1
(43) Pub. Date: Feb. 11, 2016

(54) SYSTEM AND METHOD FOR ENHANCING ALTITUDE SITUATIONAL AWARENESS ON A VERTICAL SITUATION DISPLAY

(71) Applicant: HONEYWELL INTERNATIONAL INC., Morristown, NJ (US)

(72) Inventors: Subash Samuthirapandian, Tirunelveli Dt (IN); Markus Alan Johnson, Blue River, OR (US)

(73) Assignee: HONEYWELL INTERNATIONAL INC., Morristown, NJ (US)

(21) Appl. No.: 14/456,519

(22) Filed: Aug. 11, 2014

(51) Int. Cl. G01C 23/00

(52) U.S. Cl. CPC G01C 23/00

(57) ABSTRACT

A method and apparatus is provided for graphically displaying up-linked and down-linked messages on an aircraft cockpit display. After determining if the message was up-linked or down-linked, symbology graphically representative of whether the message was up-linked or down-linked is generated and displayed along with the message content. The message content may be an altitude change request for display on a VSD.

### TECHNICAL FIELD

The present invention relates generally to avionics display systems and, more particularly, to a Vertical Situation Display (VSD) system and method for displaying up-linked and down-linked altitude change requests to enhance a pilot's vertical situational awareness.

### BACKGROUND

A pilot is faced with two major tasks; i.e. (1) to accurately determine and remain constantly aware of the current aircraft status including direction, speed, altitude, location, and the rates of change of each; and (2) to quickly and accurately control the aircraft to effectuate a change in these parameters to achieve a desired status of the aircraft including, for example, setting or altering the aircraft's flight-plan.

To this end, avionics display systems deployed aboard aircraft have been extensively engineered to visually convey a considerable amount of flight information in an intuitive and readily comprehendible manner. In conventional avionics display systems, much of the information visually expressed on a cockpit display (e.g., a primary flight display, a horizontal map display, a vertical situation display, etc.) pertains to aircraft parameters (e.g., the heading, drift, roll, and pitch of the host aircraft), nearby geographical features (e.g., mountain peaks, runways, etc.), and current weather conditions (e.g. developing storm cells). A further improvement occurred with the introduction of flight management systems, a type of specialized computer that includes a database of pre-stored navigation landmarks, such as airports, or imaginary intersections (waypoints) in the sky.

In addition, pilots strive to create a precise picture of future situations using information that is currently available to them such as weather reports and forecasts, pilot reports, NOTAM (Notice to Airmen), information about other air traffic, and the like. Such information, useful for strategic decision making, inherently includes a temporal component, which may be closely associated with a location e.g. (e.g., What will the situation look like in 20 minutes at a specific location?).

The management of strategic information and optimal situational awareness are important topics in and among the aerospace industry. For example, strong emphasis has been placed on this in the development of the FAA's Next Generation Air Transportation System (NextGen) and its European counterpart Single European Sky ATM Research (SESAR), which are parallel projects intended to completely overhaul their respective airspace and air traffic management. For example, NextGen will comprise 1) automatic dependent surveillance-broadcast (ADS-B) incorporating GPS satellite signals to provide air traffic controllers and pilots with much more accurate information to help keep aircraft safely separated in the sky and on runways, (2) reducing weather-related delays by half by providing a common weather picture across the national airspace thus enabling better decision making, (3) replacing the multiple different voice switching systems that have been in use for many years with a single air/ground and ground/ground voice communications system, and (4) providing aircraft and ATM with data-link communications for traffic control clearances, instructions, and advisories improving controller productivity, enhancing capacity, and increasing safety,

With respect to this, a pilot's workload is exacerbated by having to deal with numerous sets of altitude information that emanate from various locations and graphical displays in the cockpit. For example, such information may include current aircraft altitude, altitude requested by pilots, altitude expected by Air Traffic Control (ATC), guidance panel/flight control panel selected altitude, radar display altitude, TCAS altitude filter limits, altitude requests down-linked via datalink, altitude requests up-linked via datalink, and the like.

Currently, strategic decision-making is supported by many information sources, some of them including navigation service providers (ANSP), and airline operation centers. Others include various applications installed, for example, on electronic flight bags (EFBs). Commonly, such applications require the flight crew to connect information from various devices; for example, integrating information disseminated as NOTAMs, published activation of restricted airspaces, and/or weather information with an estimate of future position. This is time-consuming and requires a significant amount of cognitive resources; e.g., navigation mechanisms are supported by pull-down menus, toolbars, dialog boxes, etc. Thus, providing each piece of information individually without a broader context does not enhance the temporal or local aspects of the information provided.

In view of the foregoing, it would be desirable to provide altitude information graphically co-located at a single location, such as on the VSD. It would further be desirable to display altitude requests that are up-linked and down-linked, as for example on a VSD, in order to provide enhanced vertical situational awareness.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Described herein is method for graphically displaying up-linked and down-linked messages on an aircraft cockpit display. The method comprises determining if the message is up-linked or down-linked, generating symbology graphically representative of whether the message was up-linked or down-linked, graphically displaying the message content on the display, and displaying the symbology on the cockpit display.

Also described herein is an avionics display system for deployment onboard an aircraft that includes a system for displaying up-linked and down-linked altitude requests. The system comprises a processor configured to (a) receive an altitude request, (b) determine if the altitude request was up-linked or down-linked, and (c) determine the chronological position in which the altitude request was received, and (d) a display system for displaying symbology indicative of whether the altitude request was up-linked or down-linked.

Also provided is a method for graphically displaying up-linked and down-linked altitude requests on a VSD. The method comprises receiving an altitude request, generating symbology graphically representative of the requested altitude, and displaying the requested altitude on the VSD. The requested altitude is numerically displayed. Symbology graphically representative of whether the message was up-linked or down-linked is generated, and the symbology is displayed on the cockpit display.

### BRIEF DESCRIPTION OF THE DRAWINGS

Embodiments of the subject matter will hereinafter be described in conjunction with the following drawing figures, wherein like numerals denote like elements, and

FIG. 1 is a block diagram of an information display system suitable for use in an aircraft in accordance with an embodiment;

FIG. 2 is a graphical view of an exemplary navigational map display and a vertical situation display suitable for use with the information display system of FIG. 1;

FIGS. 3-5 illustrate vertical situation display screens in accordance with an exemplary embodiment; and

FIG. 6 is a flow chart of an exemplary process for providing altitude request information graphically co-located at a single location on a display.

### DETAILED DESCRIPTION

The following detailed description is merely exemplary in nature and is not intended to limit the subject matter of the application and uses thereof. Furthermore, there is no intention to be bound by any theory presented in the preceding background or the following detailed description. Presented herein for purposes of explication is a certain exemplary embodiment of how a flight course may be graphically generated. For example, a graphical generation of waypoints and altitude constraints will be discussed. However, it should be appreciated that this explicated example embodiment is merely an example and a guide for implementing the novel display system and method. As such, the examples presented herein are intended as non-limiting.

Techniques and technologies may be described herein in terms of functional and/or logical block components and with reference to symbolic representations of operations, processing tasks, and functions that may be performed by various computing components or devices. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements, additional intervening elements, devices, features, or components may be present in an embodiment of the depicted subject matter. In addition, certain terminology may also be used in the following description for the purpose of reference only, and thus are not intended to be limiting.

For the sake of brevity, conventional techniques related to graphics and image processing, navigation, flight planning, aircraft controls, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

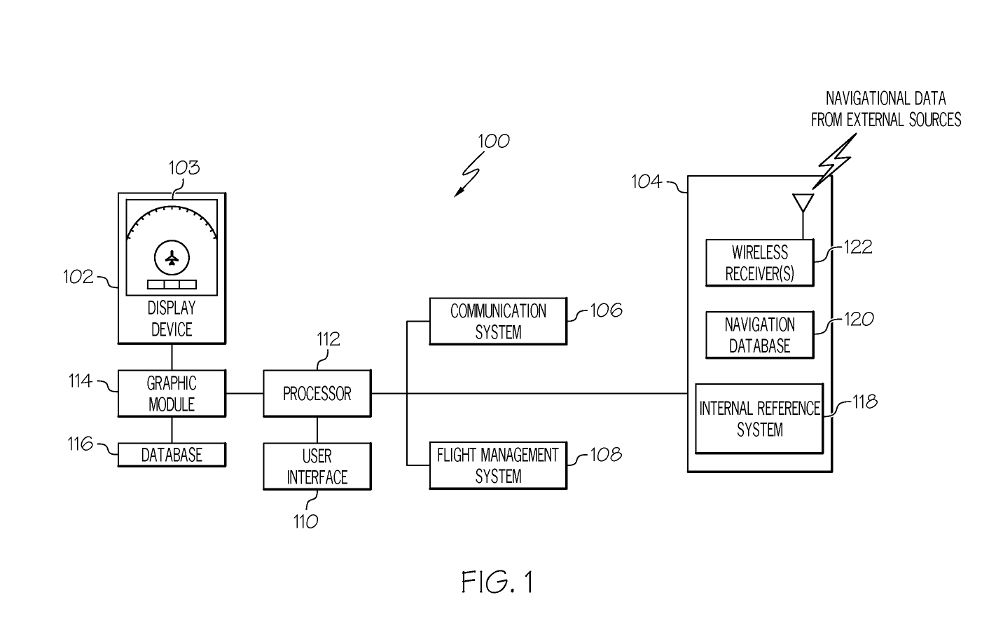

FIG. 1 depicts an exemplary embodiment of an interactive display system 100, which may be located onboard a vehicle such as an aircraft. In an exemplary embodiment, the display system 100 includes, without limitation, a display device 102 for displaying a graphical flight plan image 103, a navigation system 104, a communications system 106, a flight management system (FMS) 108, a processor 112, a graphics module 114, a user interface 110 (e.g. a cursor control device), and a database 116 suitably configured to support operation of the graphics module 114 and display device 102 (e.g. a touchscreen), as described in greater detail below. Navigation system 104 may include an inertial reference system 118, a navigation database 120 and one or more wireless receivers 122 for receiving navigational data from external sources in the well-known manner.

It should be understood that FIG. 1 is a simplified representation of an interactive display system 100 for purposes of explanation and ease of description and is not intended to limit the application or scope of the subject matter in any way. In practice, the display system 100 and/or the aircraft will include numerous other devices and components for providing additional functions and features, as will be appreciated in the art. For example, the display system 100 and/or the aircraft may include one or more avionics systems (e.g., a weather system, an air traffic management system, a radar system, a traffic avoidance system) coupled to the flight management system 108 and/or the processor 112 for obtaining and/or providing real-time flight-related information that may be displayed on the display device 102.

In an exemplary embodiment, the display device 102 is coupled to the graphics module 114. The graphics module 114 is coupled to the processor 112, the display 102, and database 116 are cooperatively configured to display, render, or otherwise convey one or more graphical representations or images such as a flight plan associated with operation of the aircraft on the display device 102.

As stated previously, navigational system 104 includes an inertial reference system 118, a navigation database 120, and at least one wireless receiver 122. Inertial reference system 118 and wireless receiver 122 provide processor 112 with navigational information derived from sources onboard and external to the host aircraft, respectively. More specifically, inertial reference system 118 provides processor 112 with information describing various flight parameters of the host aircraft (e.g., position, orientation, velocity, etc.) as monitored by a number of motion sensors (e.g., accelerometers, gyroscopes, etc.) deployed onboard the aircraft. By comparison, and as indicated in FIG. 1, wireless receiver 122 receives navigational information from various sources external to the aircraft. These sources may include various types of navigational aids (e.g., global position systems, non-directional radio beacons, very high frequency Omni-directional radio range devices (VORs), etc.), ground-based navigational facilities (e.g., Air Traffic Control Centers, Terminal Radar Approach Control Facilities, Flight Service Stations, and control towers), and ground-based guidance systems (e.g., instrument landing systems). In certain instances, wireless receiver 122 may also periodically receive Automatic Dependent Surveillance-Broadcast (ADS-B) data from neighboring aircraft. In a specific implementation, wireless receiver 122 assumes the form of a multi-mode receiver (MMR) having global navigational satellite system capabilities.

Navigation database 120 stores a considerable amount of information useful in flight planning. For example, navigation database 120 can contain information pertaining to the geographical location of waypoints and lists of available approaches that may be flown by an aircraft when landing at a particular runway. During flight planning, a pilot may utilize user interface 110 to designate a desired approach from a list of available approaches stored in navigational database 120. After the pilot designates the desired approach, processor 112 may then recall from navigational database 120 relevant information pertaining to the designated approach.

Processor 112 is coupled to navigation system 104 for obtaining real-time navigational data and/or information regarding operation of the aircraft to support operation of the display system 100. In an exemplary embodiment, the communications system 106 is coupled to the processor 112 and configured to support communications to and/or from the aircraft, as is appreciated in the art. The processor 112 is also coupled to the flight management system 108, which in turn, may also be coupled to the navigation system 104 and the communications system 106 for providing real-time data and/or information regarding operation of the aircraft to the processor 112 to support operation of the aircraft. In an exemplary embodiment, the user interface 110 (e.g. touchscreen or cursor control) is coupled to the processor 112, and the user interface 110 and the processor 112 are cooperatively configured to allow a user to interact with display device 102 and other elements of display system 100, as described in greater detail below.

In an exemplary embodiment, the interactive display device 102 is realized as an electronic display configured to graphically display flight information or other data associated with operation of the aircraft under control of the graphics module 114. In an exemplary embodiment, the display device 102 is located within a cockpit of the aircraft. It will be appreciated that although FIG. 1 shows a single display device 102, in practice, additional display devices may be present onboard the aircraft. In an exemplary embodiment, the user interface 110 is also located within the cockpit of the aircraft and adapted to allow a user (e.g., pilot, co-pilot, or crew member) to interact with the remainder of display system 100 and enables a user to indicate, select, or otherwise manipulate content displayed on the display device 102, as described in greater detail below. In various embodiments, the user interface 110 may be realized as a keypad, touchpad, keyboard, cursor control, touchscreen, joystick, knob, microphone, or another suitable device adapted to receive input from a user. In preferred embodiments, user interface 110 may be a touchscreen, cursor control device, joystick, or the like.

In an exemplary embodiment, the navigation system 104 is configured to obtain one or more navigational parameters associated with operation of the aircraft. The navigation system 104 may be realized as a global positioning system (GPS), inertial reference system (IRS), or a radio-based navigation system (e.g., VHF Omni-directional radio range (VOR) or long range aid to navigation (LORAN)), and may include one or more navigational radios or other sensors suitably configured to support operation of the navigation system 104, as will be appreciated in the art. In an exemplary embodiment, the navigation system 104 is capable of obtaining and/or determining the instantaneous position of the aircraft, that is, the current location of the aircraft (e.g., the latitude and longitude) and the altitude or above ground level for the aircraft. The navigation system 104 may also obtain and/or determine the heading of the aircraft (i.e., the direction the aircraft is traveling in relative to some reference).

In an exemplary embodiment, the communications system 106 is suitably configured to support communications between the aircraft and another aircraft or ground location (e.g., air traffic control). In this regard, the communications system 106 may be realized using a radio communication system or another suitable data link system. In an exemplary embodiment, the flight management system 108 (or, alternatively, a flight management computer) is located onboard the aircraft. Although FIG. 1 is a simplified representation of display system 100, in practice, the flight management system 108 may be coupled to one or more additional modules or components as necessary to support navigation, flight planning, and other aircraft control functions in a conventional manner.

In an exemplary embodiment, the flight management system 108 maintains information pertaining to a current flight plan (or alternatively, a current route or travel plan). In this regard, depending on the embodiment, the current flight plan may comprise either a selected or otherwise designated flight plan for subsequent execution, a flight plan selected for review on the display device 102, and/or a flight plan currently being executed by the aircraft. In this regard, as used herein, a flight plan should be understood as a sequence of navigational reference points that define a flight path or route for the aircraft. In this regard, depending on the particular flight plan and type of air navigation, the navigational reference points may comprise navigational aids, such as VHF Omni-directional ranges (VORs), distance measuring equipment (DMEs), tactical air navigation aids (TACANs), and combinations thereof (e.g., VORTACs), landing and/or departure locations (e.g., airports, airstrips, runways, landing strips, heliports, helipads, and the like), points of interest or other features on the ground, as well as position fixes (e.g., initial approach fixes (IAFs) and/or final approach fixes (FAFs)) and other navigational reference points used in area navigation (RNAV). For example, a flight plan may include an initial or beginning reference point (e.g., a departure or takeoff location), a final navigational reference point (e.g., an arrival or landing location), and one or more intermediate navigational reference points (e.g., waypoints, positional fixes, and the like) that define the desired path or route for the aircraft from the initial navigational reference point to the final navigational reference point. In this regard, the intermediate navigational reference points may define one or more airways for the aircraft en route to the final navigational reference point.

In an exemplary embodiment, the processor 112 and/or graphics module 114 are configured to display and/or render symbology pertaining to altitude change requests that are either up-linked (e.g., from ATC) or down-linked (e.g., to ATC).

The processor 112 generally represents the hardware, software, and/or firmware components configured to facilitate the display and/or rendering of a navigational map on the display device 102 and perform additional tasks and/or functions described in greater detail below. Depending on the embodiment, the processor 112 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. The processor 112 may also be implemented as a combination of computing devices, e.g., a combination of a digital signal processor and a microprocessor, a plurality of microprocessors, one or more microprocessors in conjunction with a digital signal processor core, or any other such configuration. In practice, the processor 112 includes processing logic that may be configured to carry out the functions, techniques, and processing tasks associated with the operation of the display system 100, as described in greater detail below. Furthermore, the steps of a method or algorithm described in connection with the embodiments disclosed herein may be embodied directly in hardware, in firmware, in a software module executed by the processor 112, or in any practical combination thereof.

The graphics module 114 generally represents the hardware, software, and/or firmware components configured to control the display and/or rendering of a navigational map on the display device 102 and perform additional tasks and/or functions described in greater detail below. In an exemplary embodiment, the graphics module 114 accesses one or more databases 116 suitably configured to support operations of the graphics module 114, as described below. In this regard, the database 116 may comprise a terrain database, a weather database, a flight plan database, an obstacle database, a navigational database, a geopolitical database, a terminal airspace database, a special use airspace database, or other information for rendering and/or displaying content on the display device 102, as described below. It will be appreciated that although FIG. 1 shows a single database 116 for purposes of explanation and ease of description, in practice, numerous databases will likely be present in a practical embodiment of the display system 100.

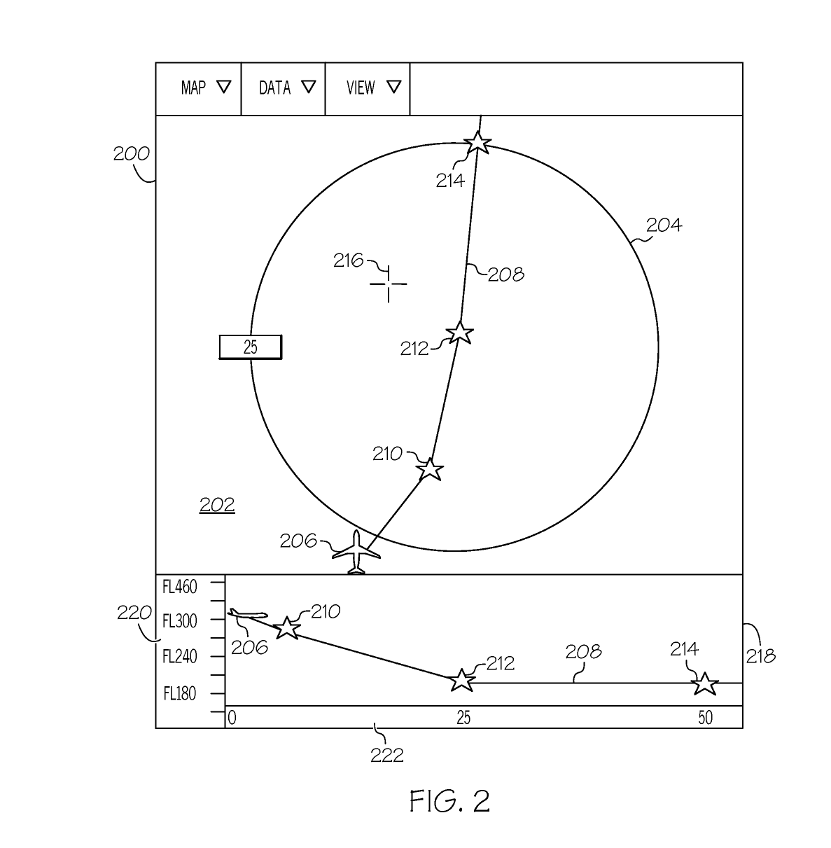

FIG. 2 is an exemplary illustration of a graphical display comprising a navigational map 200 and an airspace overlay 202. The processor 112, database 116, and graphics module 114 (FIG. 1) nay be configured to render navigational map 200 to display terrain, topology, and other suitable items or points of interest within a given distance from the aircraft. The pilot may set the threshold distance of the viewable area by zooming-in to display a smaller geographic area or zooming-out to display a larger geographic area. The relative scale of the area is shown by a range ring 204 having a number “25’ thereon indicating that the range of the range ring is twenty-five nautical miles. Referring to FIG. 2, map 200 suitably includes an aircraft indicator 206 on a flight path indicator 208, which shows the path to be flown by aircraft 206. The flight plan may be marked by a series of waypoints 210, 212, and 214 on FIG. 2. Each waypoint may correspond to a navigational aid, an airport, or any other point on a map. The flight plan shown in FIG. 2, for example, shows the aircraft flying to waypoint 210, then turning toward waypoint 212, and continuing on to waypoint 214. A typical flight plan image may be represented as a series of flight segments from waypoint to waypoint, terminating at a destination airport.

Located below navigational map 200 is a vertical situation display (VSD) 218 further illustrating the airspace being entered or selected by a user. The selected airspace is displayed on VSD 218 in a manner consistent with how the airspace is displayed in map display 200. VSD includes a vertical altitude scale 220, a horizontal distance scale 222, and illustrates a vertical profile view of flight plan 208 including waypoints 210, 212, and 214.

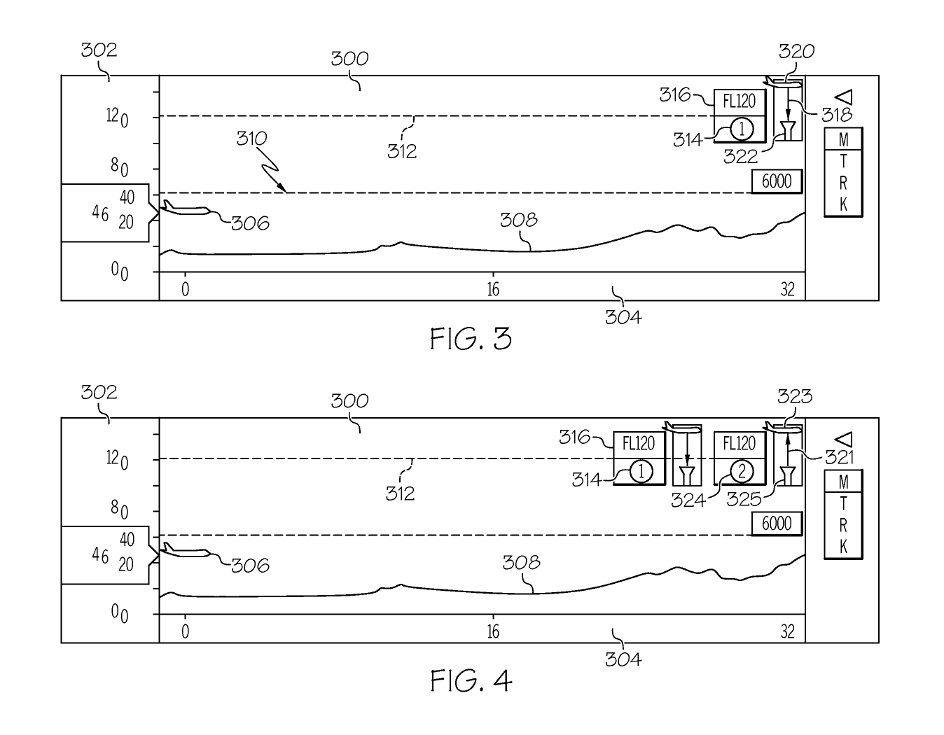

In accordance with exemplary embodiments described below in connection with FIGS. 3-5, it is contemplated that both up-linked and down-linked messages are decoded, and any altitude change requests found therein identified. The requested altitudes will then be displayed. By way of example, the requested altitude changes will be displayed on a VSD; however, it should be understood that the requested altitude changed could be displayed on other cockpit displays such as navigational map 200. In accordance with further embodiments, it is contemplated that the requested altitude will be displayed graphically, numerically, chronologically, and directionally.

FIGS. 3-5 each illustrate a vertical situation display (VSD) 300 having a vertical altitude scale 302 and a horizontal distance scale 304 similar to that shown in FIG. 2. Each also shows a host aircraft 306 flying over terrain 308.

Referring first to FIG. 3, there is shown a scenario wherein aircraft 306 is flying at an altitude of 4,630 feet indicated by a line 310 (e.g., dashed, solid, dotted, etc.) and requests permission from ATC to fly at 12,000 feet (FL120) as indicated by line 312 and altitude change request box 316. The number “1” in circle 314 indicates that this is the first altitude change request, and arrow 318 extending from aircraft icon 320 and points to tower icon 322 indicates that this request was sent from aircraft 306 to ATC. It should be noted that different or additional message content may be included.

Referring now to FIG. 4, a second altitude change request to fly at 12,000 feet has been received and displayed. The number “2” in circle 324 indicates that this is the second altitude change request, and arrow 321 directed toward aircraft icon 323 and away from tower icon 325 indicates that this request was made by ATC.

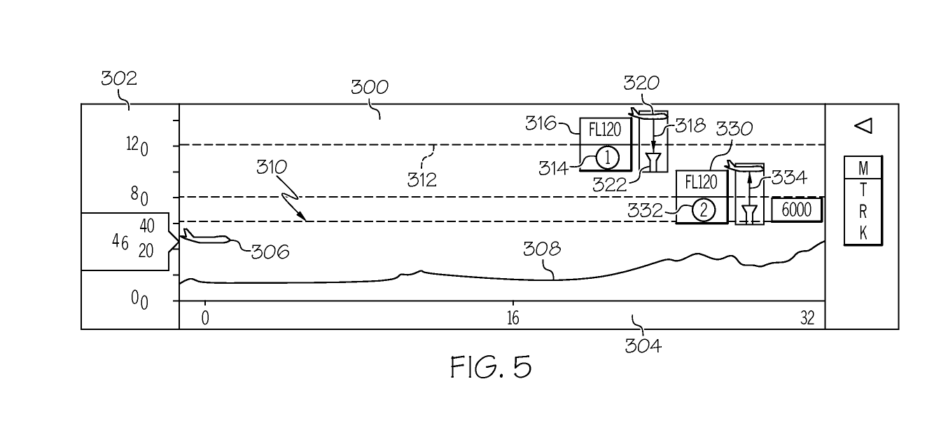

In FIG. 5, aircraft 306 has once again requested ATC permission to fly at 12,000 feet as is indicated at box 316, and once again, this is the first altitude change request as is indicated by chronological order number “1” at 314. Arrow 318 extending from aircraft icon 320 to tower icon 322 indicates that this request was sent from aircraft 306 to ATC. In this case however, ATC has up-linked a message authorizing aircraft 306 to fly at 8,000 feet (FL080), as is indicated at 330. Chronological order number “2” at 332 indicates that this is the second altitude change request, and upward directed arrow 334 indicates that it was sent by ATC to aircraft 306.

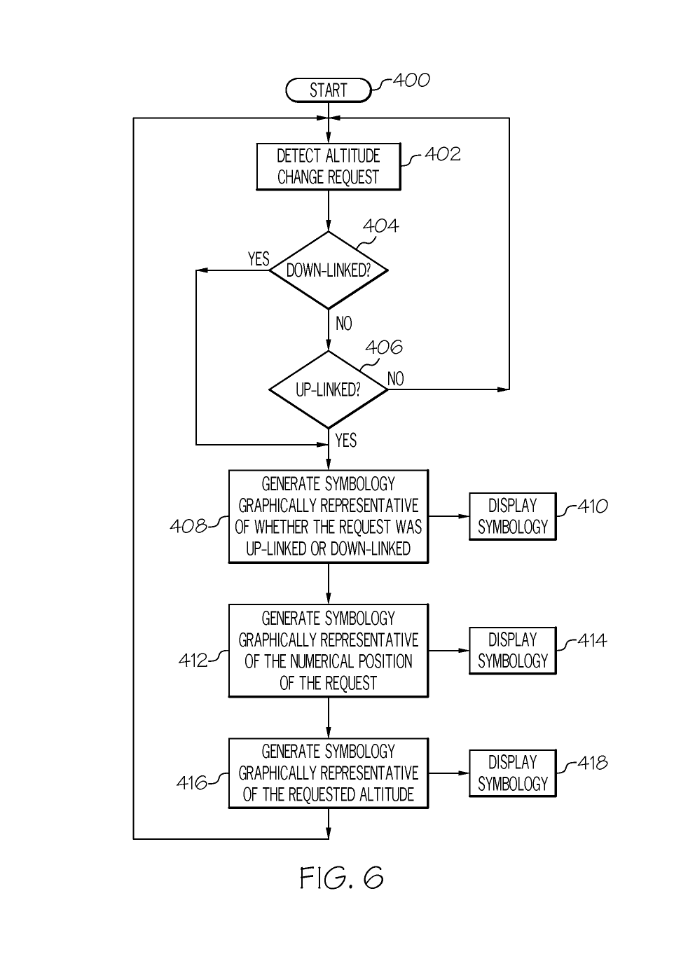

FIG. 6 is a flowchart of an interactive display process 400 for providing altitude request information graphically co-located at a single location on a VSD and displaying the altitude requests that are up-linked and down-linked in order to provide enhanced vertical situational awareness.

After an altitude request has been detected (STEP 402), STEP 404 determines if the altitude request was down-linked, and STEP 406 determines if the altitude request was up-linked. If an up-linked or down-linked altitude request is detected, graphics module 114, in conjunction with processor 112 and database 116 (see FIG. 1), generate symbology graphically representative of (1) whether the request was up-linked or down-linked (STEP 408), (2) a numerical representation of the chronological order of the request if one or more has been received (e.g., first, second, etc.) (STEP 412), and (3) an alpha-numerical representation of the requested altitude (e.g., FL 120) (STEP 416). In each case, the results are grouped and displayed on display device 102 (STEPS 410, 414, and 418) as is illustrated in FIGS. 3, 4, and 5.

Thus, it should be appreciated that there has been provided a system and method for graphically displaying altitude change requests that are up-linked and/or down-linked on a cockpit display such as a VSD thus providing enhanced altitude situational awareness as distinguished from other altitudes such as current aircraft altitude, verbally requested altitude, guidance panel/flight control panel selected altitude, TCAS altitude filter limits, etc. Furthermore, the concepts described herein are also applicable to heading changes, offset flying, speed change requests, etc. that comprise up-linked and/or downlinked messages.

While an exemplary embodiment of the present invention has been described above in the context of a fully functioning computer system (i.e., avionics display system 100), those skilled in the art will recognize that the mechanisms of the present invention are capable of being distributed as a program product (i.e., an avionics display program) and, furthermore, that the teachings of the present invention apply to the program product regardless of the particular type of computer-readable media (e.g., floppy disc, hard drive, memory card, optical disc, etc.) employed to carry-out its distribution.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for graphically displaying up-linked and down-linked messages on an aircraft cockpit display, the method comprising:
determining if a message is up-linked or down-linked;
generating symbology graphically representative of whether the message was up-linked or down-linked;
graphically displaying the message content on the display; and
displaying the symbology on the cockpit display.

2. The method of claim 1 wherein the message comprises an altitude change request.

3. The method of claim 2 wherein the message includes a requested altitude.

4. The method of claim 3 further comprising:
determining the order in which the request was received;
generating symbology numerically representative of the order in which the request was received; and
displaying the order on the display.

5. The method of claim 4 wherein the symbology representative of whether the altitude request was up-linked or down-linked comprises an arrow pointed upward if the request was up-linked.

6. The method of claim 5 wherein the arrow is pointed downward if the request was down-linked.

7. The method of claim 5 further comprising generating and displaying symbology graphically representative of an aircraft icon, wherein the arrow is directed toward the aircraft icon if the request was up-linked.

8. The method of claim 7 further comprising generating and displaying symbology graphically representative of a tower icon, wherein the arrow is pointed toward the tower icon if the altitude request was down-linked.

9. The method of claim 8 wherein the arrow is displayed between the tower icon and the aircraft icon on the display.

10. The method of claim 9 wherein the arrow, the tower icon, the aircraft icon, and the requested altitude are located proximate each other on the display.

11. The method of claim 10 wherein sequential altitude requests are graphically displayed on the display in the order of received.

12. The method of claim 1 wherein the messages are displayed on a vertical situation display.

13. A method for graphically displaying up-linked and down-linked altitude requests on a VSD, the method comprising:
receiving an altitude request;
generating symbology graphically representative of the requested altitude;
displaying the requested altitude on the VSD;
generating symbology graphically representative of whether the message was up-linked or down-linked; and
displaying the symbology on the VSD.

14. The system of claim 13 wherein the symbology representative of whether the altitude request was up-linked or down-linked comprises an arrow pointed upward if the request was up-linked.

15. The system of claim 14 wherein the arrow is displayed between the tower icon and the aircraft icon on the display.

16. The system of claim 15 wherein sequential altitude requests are graphically displayed on the display in the order of received.

17. The system of claim 16 wherein the arrow, the tower icon, the aircraft icon, and the requested altitude are located proximate each other on the display.

18. A system for displaying up-linked and down-linked altitude requests, comprising:
a processor configured to (a) receive an altitude request, (b) determine if the altitude request was up-linked or down-linked, and (c) determine the chronological position in which the altitude request was received; and
a display system for displaying symbology indicative of whether the altitude request was up-linked or down-linked.

19. The system of claim 18 wherein the processor is further configured to generate symbology numerically representing the requested altitude.

20. The system of claim 19 wherein the processor is further configured to generate symbology graphically representative of an arrow pointed upward if the altitude request is up-linked and downward if the altitude request is down-linked.
